(19) United States
(12) Patent Application Publication
(10) Pub. No.: US 2007/0274516 A1
(43) Pub. Date: Nov. 29, 2007

(54) Mode dial mechanism

(76) Inventor: Tzu-Chih Lin, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/429,195

(22) Filed: May 8, 2006

(51) Int. Cl. H04M 1/00; H04M 9/00

(52) U.S. Cl. 379/419

(57) ABSTRACT

A model dial mechanism comprises a circuit board provided with a mode layout circuit, several dome elements, and a mode dial button. The dome elements are provided at intervals on the circuit board to correspond to the mode layout circuit. The mode dial button is rotatably provided on the circuit board, so that the dome elements are electrically connected to the corresponding mode layout circuit. Make use of this, the mode dial mechanism can provide a well-contact effect.

### BACKGROUND OF THE INVENTION

1. Field of the Invention

The present invention relates to a mode dial mechanism, and in particular to a mode dial mechanism having a well-contact effect.

2. Description of Prior Art

Mode dial mechanism is widely used in daily life, especially in various electronic products. For example, the mode dial mechanism can be used to switch the function modes of a digital camera or mobile phone. Therefore, with the mode dial mechanism, a user can select and switch various function modes.

With reference to FIG. 1, a conventional mode dial mechanism comprises a circuit board 10a, a rotary switch 20a and a mode dial button 30a.

The circuit board 10a is provided with a mode layout circuit (not shown) and several contacts 11a corresponding to the mode layout circuit.

The rotary switch 20a is provided on the circuit board 10a and has a pair of electric brush elastic pieces 21a movable along with the rotation of the rotary switch 20a.

The mode dial button 30a is fixedly provided on the rotary switch 20a. By rotating the mode dial button 30a, the rotary switch 20a is driven to rotate and then the pair of electric brush elastic pieces 21a can move to elastically connect with the several contacts 11a on the circuit board 10a. As a result, the mode layout circuit provided on the circuit board 10a can be driven to achieve the effect of switching various modes.

However, the rotary switch 20a used in the conventional model dial mechanism is complicated in structure and high in cost. Further, the electric brush elastic pieces 21a are easy to get deformed due to the dust or incorrect assembling, causing the poor contact with the contacts 11a of the circuit board 10a. As a result, the function of switching modes is affected.

In view of the above, the inventor proposes the present invention to overcome the above problems based on his expert experiences and deliberate researches.

### SUMMARY OF THE INVENTION

The primary object of the present invention is to provide a mode dial mechanism having a well-contact effect and less cost.

In order to achieve the above object, the present invention provides a mode dial mechanism comprising: a circuit board provided with a mode layout circuit; several dome elements provided at intervals on the circuit board to correspond to the mode layout circuit on the circuit board; and an mode dial button rotatably provided on the circuit board, wherein the mode dial button presses on the dome elements to bring the dome elements into electrical contact with the corresponding mode layout circuit.

In order to better understand the technique, method and effects employed by the present invention, a detailed description relating to the present invention will be made with reference to the accompanying drawings. However, it should be understood that the drawings are illustrative but not used to limit the scope of the present invention.

### BRIEF DESCRIPTION OF THE DRAWINGS

FIG. 1 is a perspective view of a conventional mode dial mechanism;

FIG. 2 is a perspective view showing the mode dial mechanism of a first embodiment of the present invention;

FIG. 3 is a cross-sectional view showing a thin film button of the mode dial mechanism of the present invention;

FIG. 4 is a perspective view showing the mode dial mechanism of a second embodiment of the present invention; and

FIG. 5 is a perspective view showing the mode dial mechanism of a third embodiment of the present invention.

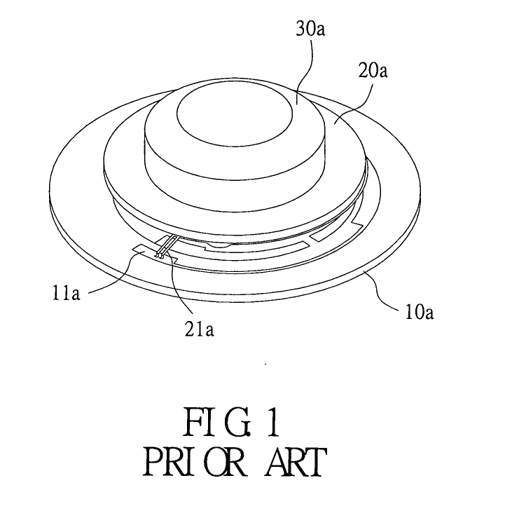

### DETAILED DESCRIPTION OF THE INVENTION

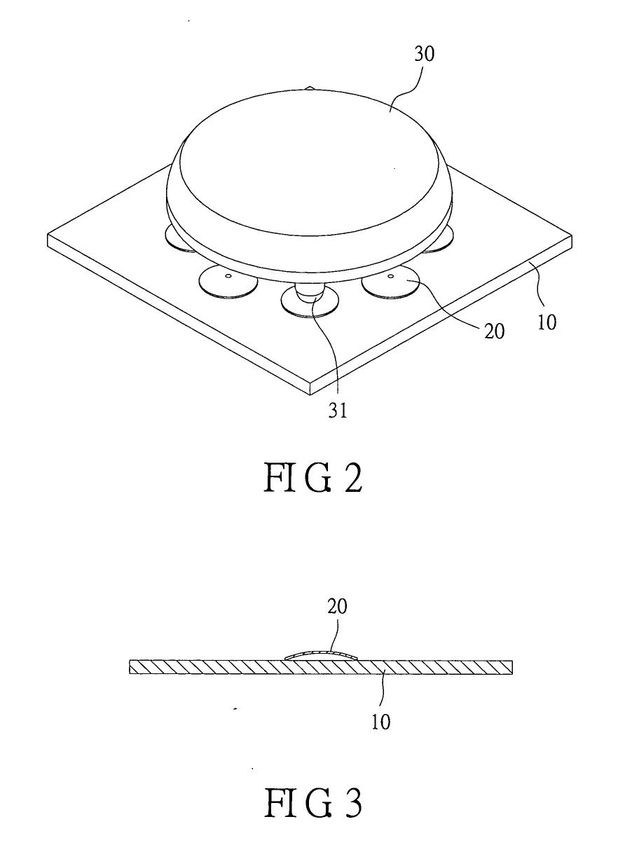

With references to FIGS. 2 and 3, which illustrate a mode dial mechanism of the first embodiment of the present invention comprising a circuit board 10, several dome elements 20 and a mode dial button 30.

The circuit board 10 is provided with a mode layout circuit (not shown) for switching various modes.

The dome elements 20 are several dome buttons formed into a convex shape and made of metallic material. The dome elements 20 are provided at intervals on the circuit board 10 to correspond to the mode layout circuit. Each dome element 20 is electrically connected to the corresponding mode layout circuit.

The mode dial button 30 is formed into a disk-like shape and rotatably provided on the circuit board 10. A spherical body 31 extends from the lower end of the mode dial button 30 to correspond to the dome elements 20, respectively. By rotating the mode dial button 30 to drive the spherical body 31 to move sequentially to the upside of each dome element 20, the spherical body 31 presses on each dome element 20 to electrically connect with the corresponding mode layout circuit. In this way, the effect of switching various modes can be achieved.

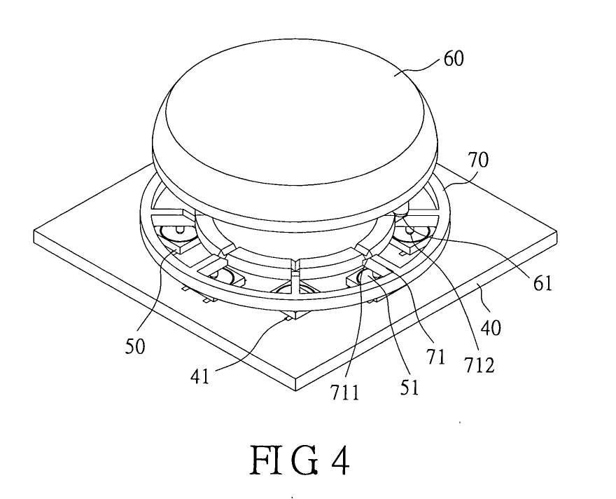

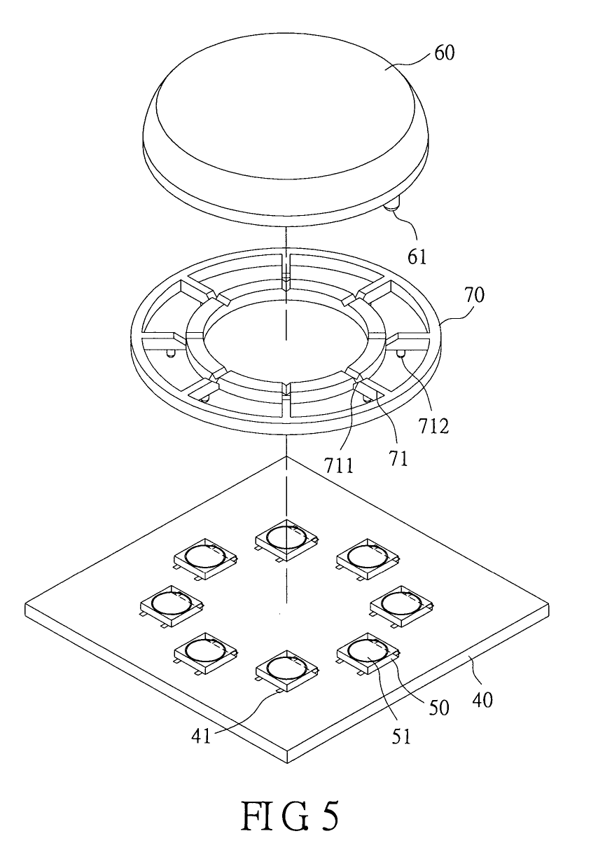

With references to FIGS. 4 and 5, which illustrate a mode dial mechanism of the second embodiment of the present invention comprising a circuit board 40, several dome elements 50, a mode dial button 60 and a frame 70

The circuit board 40 is provided with a mode layout circuit (not shown) and several contacts 41 corresponding to the mode layout circuit. The surfaces of the contacts 41 are subjected to a Hot Air Solder Leveling (HASL) to form a solder-leveling surface.

The dome elements 50 are several dome switches made by SMT (Surface Mount Technology). The surfaces of the dome elements 50 are adhered to the contacts 41, so that the dome elements 50 are electrically connected to the circuit board 40. The interior of each dome element 50 is provided with a connectable contact (not shown). The upper end of each dome element 50 is provided with a dome button 51. By pressing the dome button 51, the contacts within the dome elements 50 can be electrically connected.

The mode dial button 60 is formed into a disk-like shape and rotatably provided on the circuit board 40. A spherical body 61 extends from the underside of the mode dial button 60 for switching various modes.

The frame 70 is a hollow circular frame and is obliquely provided between the mode dial button 60 and the circuit board 40. The frame 70 is provided with several supports 71. The upper end of each support 71 is provided with an inclined portion 711 each corresponding to the spherical body 61. The lower end of each support is provided with a projecting post 712 each corresponding to the dome element 50. By rotating the mode dial button 60 to move the spherical body 61 to the upside of the inclined portion 711, due to the inclination of the inclined portion 711, the spherical body 61 naturally produces a downward force to press on the frame 70 when contacting with the inclined portion 711. As a result, the frame 70 inclines downwardly and the projecting post 712 presses on the dome button 51 corresponding to the dome element 50. Then, the mode dial button 60 presses downwardly on the dome element 50 via the frame 70 to electrically connect to the contacts within the dome element 50. With the electrical connect between the dome element 50 and the circuit board 40, the mode layout circuit on the circuit board 40 can be driven to achieve the effect of switching modes.

In view of the above, since the mode dial mechanism of the present invention drives the mode layout circuit via the dome elements, the poor contact caused by the dust or incorrect assembling can be avoided. According to the present invention, the cost is reduced and the yield is improved. Therefore, the present invention indeed solves the drawbacks of prior art.

Although the present invention has been described with reference to the foregoing preferred embodiments, it will be understood that the invention is not limited to the details thereof. Various equivalent variations and modifications can still be occurred to those skilled in this art in view of the teachings of the present invention. Thus, all such variations and equivalent modifications are also embraced within the scope of the invention as defined in the appended claims.

What is claimed is:

1. A mode dial mechanism, comprising:
a circuit board provided with a mode layout circuit;
a plurality of dome elements spaced apart on the circuit board in correspondence to the mode layout circuit of the circuit board; and
a mode dial button rotatably provided on the circuit board;
wherein the mode dial button presses on the dome elements to bring the dome elements into electrical contact with the corresponding mode layout circuit.

2. The mode dial mechanism according to claim 1, further comprising a frame obliquely provided between the mode dial button and the circuit board, and a projecting post corresponding to each dome element.

3. The mode dial mechanism according to claim 1, wherein the dome elements comprise at least one dome button.

4. The mode dial mechanism according to claim 3, wherein the dome button is made of metallic material.

5. The mode dial mechanism according to claim 1, wherein the dome elements comprise at least one dome switch.

6. The mode dial mechanism according to claim 5, wherein the dome switch is a switch made by Surface Mount Technology.

7. The mode dial mechanism according to claim 1, wherein a spherical body extends from the mode dial button in correspondence to the dome elements, respectively.
